(19) United States
(12) Patent Application Publication
(10) Pub. No.: US 2008/0149662 A1
(43) Pub. Date: Jun. 26, 2008

(54) System and method for dispensing of viscous food product

(76) Inventor: Paul Scardino, Westwood, NJ (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/940,906

(22) Filed: Nov. 15, 2007

Related U.S. Application Data
(60) Provisional application No. 60/871,195, filed on Dec. 21, 2006.

(51) Int. Cl. G01F 11/00; B67D 5/62; B60P 3/22

(52) U.S. Cl. 222/1; 222/608; 222/146.6; 222/386

(57) ABSTRACT

A system and method that portably stores, refrigerates, and dispenses a viscous, semi-solid food product. Cannoli cream is held in a hopper that is removably received inside an insulated and cooled portion of the portable dispenser housing. The portion that receives the hopper is lined with evaporator coils from a refrigeration unit or cold packs. A piston driven mechanism is housed in the dispenser, the piston drive functioning to pump cannoli cream from the hopper through a dispenser nozzle.

### CROSS REFERENCE TO RELATED APPLICATION

This application claims priority to U.S. provisional patent application Ser. No. 60/871,195, filed Dec. 21, 2006 and entitled “SYSTEM AND METHOD FOR DISPENSING OF VISCOUS FOOD PRODUCT”, which is hereby incorporated by reference in this application in its entirety for all purposes.

### FIELD OF THE INVENTION

The present invention is directed to a system and method that portably stores, cools, and dispenses a viscous, semi-solid food product.

### BACKGROUND INFORMATION

Traditionally, a cannoli shell should be held in a hand with the central hollow cavity horizontally oriented and the prepared cannoli cream is spooned into the cavity or forced into the cavity with a conventional pastry bag. When the pastry bag is empty it needs to be refilled, and refilling an already used bag is cumbersome. The capacity of cannoli cream that a pastry bag can hold is limited. This all means that the activity of refilling the pastry bag must be repeated often, which makes it both a time consuming and messy way to fill cannoli shells. When not in use, the pastry bag is promptly stored in a refrigerator to preserve the cannoli cream inside it. It can be seen that this traditional scheme for filling cannoli shells is not very efficient.

Storing food using refrigeration is a well established practice, and such storage has been combined with dispensing of food. Examples of dispensing of refrigerated food are found in U.S. Pat. No. 6,299,025 to Watanabe et al., U.S. Pat. No. 5,553,756 and U.S. Pat. No. 5,494,194, both to Topper et al., U.S. Pat. No. 6,923,006 to Walton et al., and U.S. Pat. No. 3,213,903 to Armstrong.

One problem with the dispensing structures of the arrangements described above is that they are not well adapted for use in filling cannoli shells with cannoli cream. The fixed, vertically oriented dispensers of these systems are not suitable for filling cannoli shells.

It is also noted that the storage and dispensing arrangements described above are bulky and do not lend themselves to being moved around easily in a kitchen or pastry shop.

What is needed is a system that keeps viscous, semi-solid food material cool, is capable of dispensing the food material into horizontally oriented cavities, and which is portable.

### SUMMARY OF THE INVENTION

A first embodiment of the invention is a dispenser for filling cannoli shells with cannoli cream (the term “cream” or “filling” are use interchangeably herein to denote any viscous food material). The dispenser is portable so that it may be moved to any desired location. The dispenser has one or more cold packs to keep the cannoli cream chilled.

According to this first embodiment, the cannoli filling is held in a hopper that is removably received in a top portion of the dispenser that is sized to receivably house the hopper through a side opening. The top portion that receives the hopper is has structures for holding one or more cold packs, such as ice or an ice substitute material to absorb heat energy.

A second embodiment is a dispenser for filling cannoli shells with cannoli cream. The dispenser is portable so that it may be moved to any desired location. The dispenser has a refrigeration unit to keep the cannoli cream chilled.

According to this second embodiment, the cannoli filling is held in a hopper that is removably received in a top portion of the dispenser that is sized to receivably house the hopper through a top opening. The top portion that receives the hopper is lined with evaporator coils from a refrigeration unit, the other components of the refrigeration unit (condenser coils, compressor, expansion valve, etc.) being housed in a bottom portion of the portable dispenser.

A third embodiment is a portable dispenser for filling cannoli shells with cannoli cream. The dispenser has one or more cold packs to keep the cannoli cream chilled. The use of cold packs is supplemented by an thermoelectric cooling system. The thermoelectric cooling structure waits in a standby mode until such time as the cold packs begin to lose the ability to maintain cool temperature in the cold chamber. The thermoelectric system then activates to provides a supplemental cooling capacity.

According to the various embodiments, a piston driven mechanism is housed in the dispenser, the piston drive functioning to pump cannoli filling from the hopper to a dispenser nozzle. Optionally, the cannoli filling is pumped through a flexible tube to the nozzle.

One embodiment holds a viscous, flowable food material, stores the material at a cooled temperature, and dispenses the material.

Another embodiment stores a viscous, flowable food material, dispenses the material, and is portable.

Another embodiment stores a viscous, flowable food material at a cooled temperature and dispenses the material using a nozzle.

### BRIEF DESCRIPTION OF THE DRAWINGS

FIG. 1 illustrates a perspective view of a cannoli cream dispenser according to a first embodiment.

FIG. 2 illustrates an elevation partial section view of a cannoli cream dispenser according to the first embodiment.

FIG. 3 illustrates a plan partial section view of a cannoli cream dispenser according to the first embodiment.

FIG. 4 illustrates a detail view of ice pack holding cups structure of a cannoli cream dispenser according to the first.

FIG. 5 illustrates an elevation view of a cannoli cream dispenser according to the first embodiment showing retractable handle and wheels structures.

FIG. 6 illustrates a perspective detail view of a loading door for use on a cannoli cream dispenser according to the first embodiment.

FIG. 7 illustrates a rear elevation view of a cannoli cream dispenser according to the first embodiment.

FIG. 8 illustrates an elevation view of a cannoli cream dispenser according to the first embodiment in combination with an accessory cabinet.

FIG. 9 illustrates an elevation view of a cannoli cream dispenser according to the second embodiment.

FIG. 10 illustrates an exploded view of a cannoli cream dispenser according to the second embodiment.

FIG. 11 illustrates a section view of a cannoli cream dispenser according to the second embodiment.

FIG. 12 illustrates a detail view of refrigeration coil structure of a cannoli cream dispenser according to the second embodiment.

FIG. 13 illustrates a removable drop-in hopper for use in a cannoli cream dispenser according to the second embodiment.

FIG. 14 illustrates a detail view of a lid and latch structure of a cannoli cream dispenser according to the second embodiment.

FIG. 15 illustrates a front elevation view of a jacket for use on a cannoli cream dispenser according to the second embodiment.

FIG. 16 illustrates a rear elevation view of a jacket for use on a cannoli cream dispenser according to the second embodiment.

FIG. 17 illustrates an elevation view of a cannoli cream dispenser according to a third embodiment.

### DETAILED DESCRIPTION

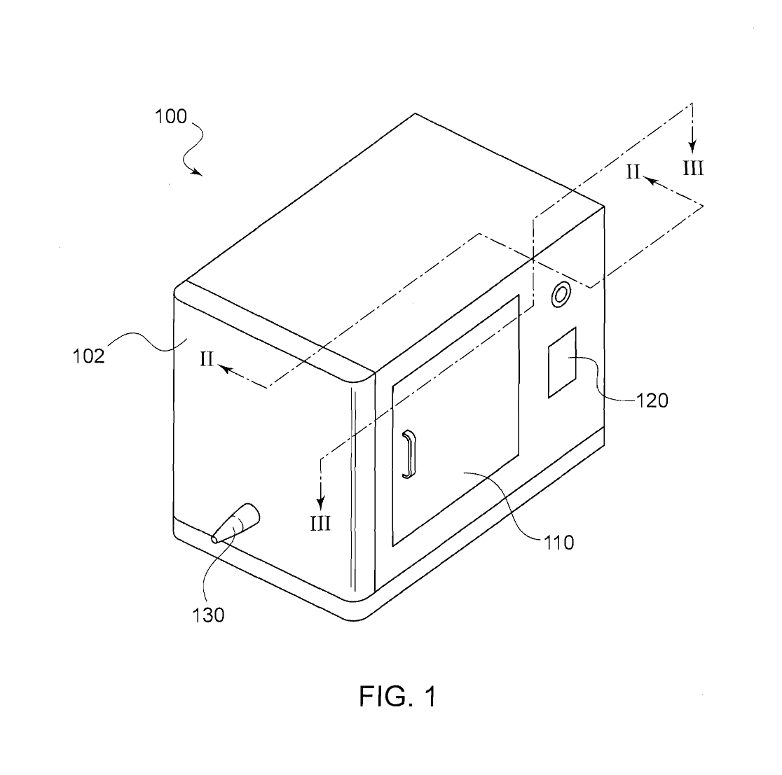

Referring to FIG. 1, a perspective view of a cannoli cream dispenser 100 is illustrated according to a first embodiment of the present invention. The dispenser has a side door 110 and a temperature readout 120 to indicate the internal temperature of cannoli cream held inside the dispenser. A nozzle 130, from which the cannoli cream is dispensed, projects from the front panel 102 of the dispenser.

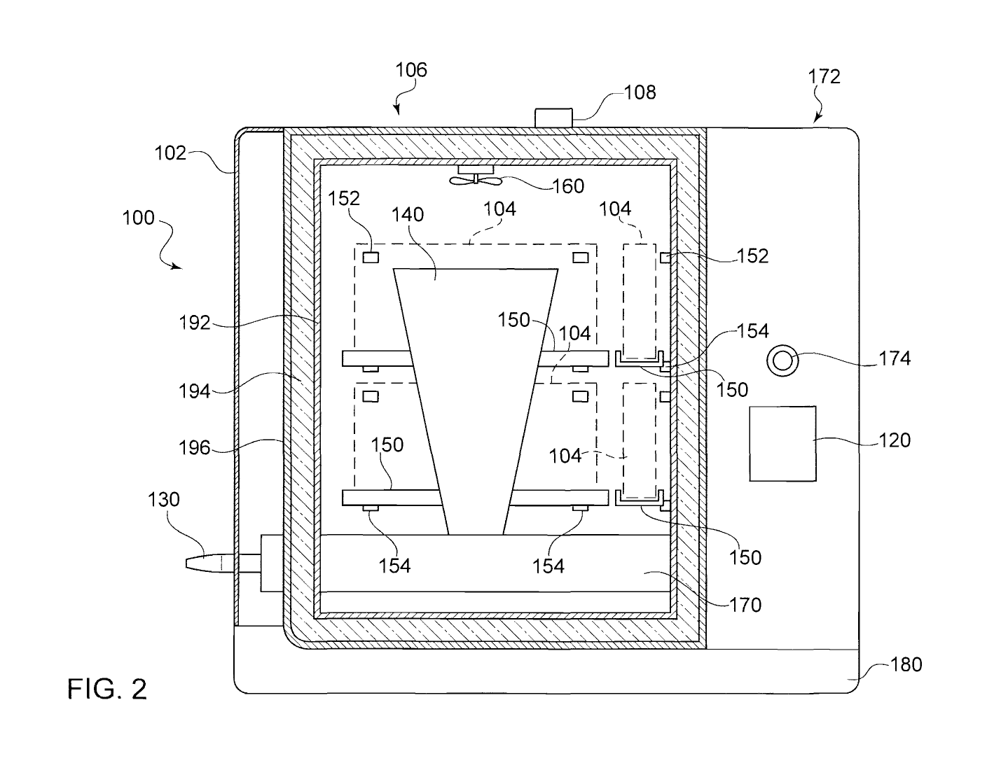

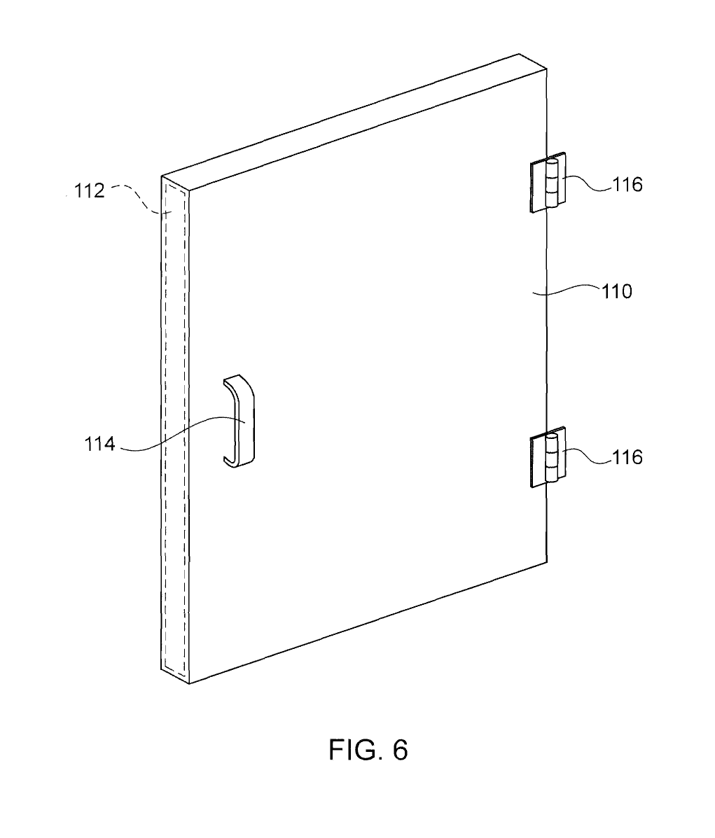

Referring to FIG. 2, an elevation partial section view of a cannoli cream dispenser is illustrated according to the first embodiment of the present invention. The dispenser 100 is portable and contains structures to accommodate cold packs 104 (blocks of ice or other thermal storage media) to keep the cannoli cream filling chilled. The cannoli filling is held in a hopper 140 that is removably received through the door 110 (refer to FIGS. 1, 3, and 6) in the side of the dispenser 100 in a forward section 106 that is sized to receivably house the hopper 140. A magnetic latch 112 (refer to FIG. 6) is used to fasten the door 110 shut on the side of the dispenser. A transport handle 108 is mounted to facilitate moving the dispenser 100; either for placing it on a countertop or rolling it on removable wheels (refer to FIG. 5). The nozzle 130 projects from the front side 102 of the dispenser 100. The forward section 106 that receives the hopper contains removable cold packs 104 (shown in phantom) mounted on support rails 150.

The forward section 106 is insulated to help keep the temperature cold around the hopper 140. A layer of R6.5 (for example but without limitation) insulation 194 is sandwiched between a rigid inner wall 196 and a rigid outer wall 192. The walls 192, 196 are advantageously formed of plastic or metal (e.g., stainless steel).

A fan 160 is mounted inside the forward section 106 to cause circulation of air around and between the cold packs 104 and the hopper 140. Air flow between the cold packs 104 and the inner walls 196 is facilitated by spacers 152 and positioning of the support rails 150 with respect to the walls 196 by spacing connectors 154. The spacers 152 and the rails 150 keep the cold packs 104 positioned at a distance from the walls 196 so as to facilitate movement of air around the cold packs 104. In this view the cold packs 104 are shown in phantom to help illustrate the spacers 152.

A pump 170 draws product (e.g., cannoli filling) from the hopper 140 and directs it to the nozzle 130. The pump 170 may be electric, pneumatic, hydraulic, or manually powered.

The rear section 172 of the dispenser provides for housing of power and measurement devices. Power supplies for the fan 160 and pump 170 are housed in the rear section 172, as is the temperature measurement circuitry and display circuitry to support the temperature display 120. An emergency shutoff 174 is placed prominently on the exterior of the dispenser to provide an immediate safety power cutoff.

Base 180 structurally supports the rear section 172, the front section 106, and the front panel 102. The front panel 102 is removable for the purposes of ease of cleaning and so that the appearance of the front of the dispenser 100 can be customized. The front panel 102 may be formed of metal (e.g., stainless steel) or a food grade plastic material.

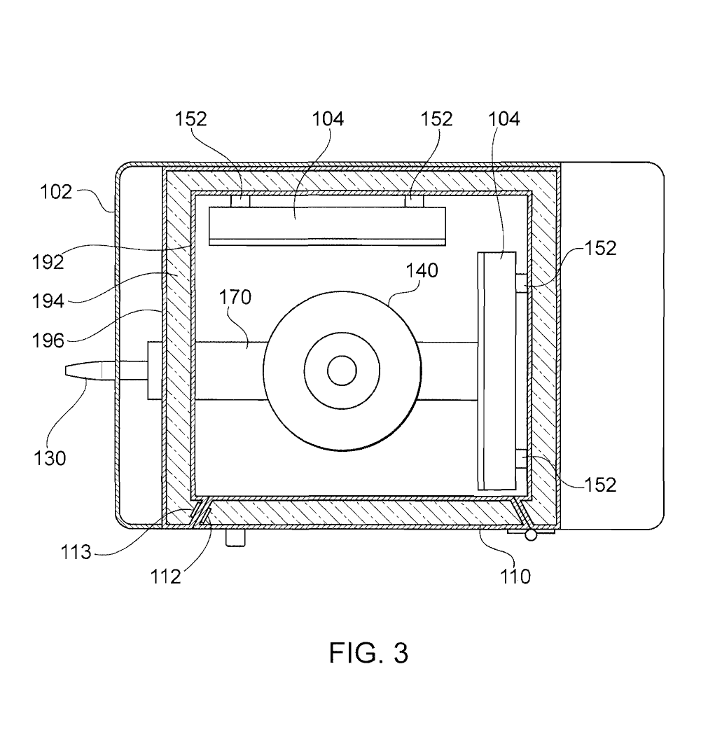

Referring to FIG. 3, a partial section plan view of a portable cannoli cream dispenser 100 is illustrated according to the first embodiment of the present invention. The dispenser 100 holds cold packs 104 to keep the cream filling chilled inside the hopper 140. The cannoli filling is held in a hopper 140 that is removably received through a door 110 in the side of the dispenser in the forward section 106 that is sized to receivably house the hopper 140. A magnetic latch, formed by magnetic members 112, 113 in the door and the door jamb, functions to hold the door 110 closed. The forward section that receives the hopper 140 has insulated walls with an insulation core 194 sandwiched between a rigid inner wall 192 and a rigid outer wall 196. The insulated space is lined with cold packs 104. The cold packs 104 are positioned to be spaced from the interior walls 192 of the forward section by spacers 152 to form a space between the cold pack and the adjacent wall through which air is free to flow.

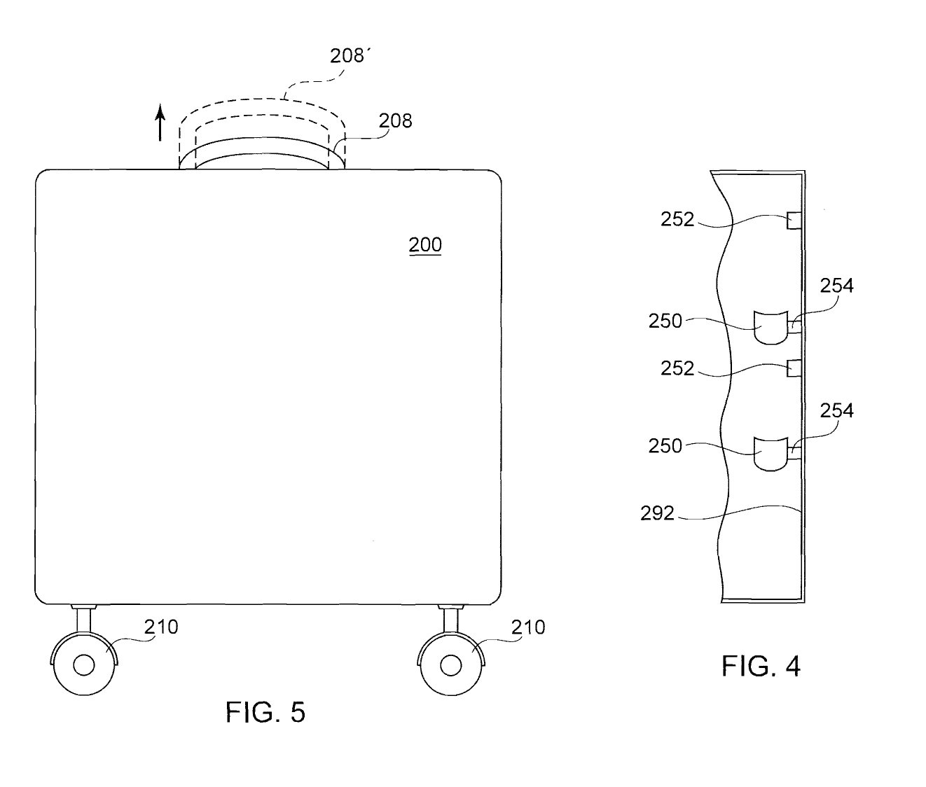

Referring to FIG. 4, a detail view of optional ice pack holding trough structure of a cannoli cream dispenser is illustrated according to the first embodiment of the present invention. When blocks of ice are used as cold packs (or “ice packs”), the holders are formed as cup-shaped troughs 250 that catch ice melt. The troughs 250 are spaced apart from the inner wall 292 by spacing connectors 254. The ice blocks (not shown in this view for clarity) are spaced apart from the inner wall 292 by spacers 252 to permit free flow of air between the ice blocks and the inner wall 292.

The liquid water melted off of the ice packs is then routed out of the front section cold chamber via a fluid conduit. The water is held in a reservoir in the dispenser, or is optionally allowed to drain out of the dispenser.

Referring to FIG. 5, an elevation view of a cannoli cream dispenser is illustrated according to the first embodiment of the present invention and showing optional features. The dispenser 200 is optionally mounted on wheels 210 for ease of transport. The wheels 210 are removable. A retractable handle 208 is optionally provided to further enable moving the dispenser 200 around. The handle is shown in phantom in a retracted position 208′ and in a stowed position 208. With wheels 210 being removable and the handle 208 being retractable, the dispenser 200 can either be placed on a countertop or rolled between work stations and storage.

Referring to FIG. 6, a perspective detail view of a loading door for use on a cannoli cream dispenser is illustrated according to the first embodiment of the present invention. The door 110 has an embedded magnetic member 112 as part of a magnetic latch to secure the door in its closed position. Opening of the door is via a pulling force on the handle 114 to overcome the hold force of the magnetic latch. The door 110 is pivotably cantilevered from hinges 116 mounted to the housing of the dispenser.

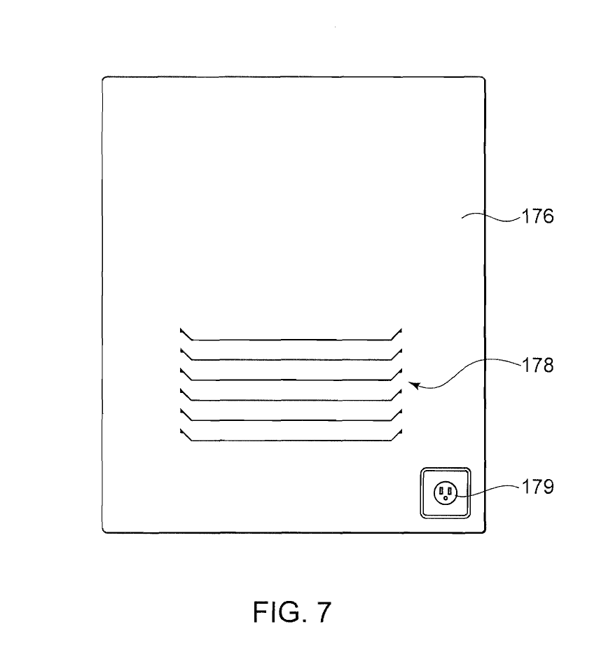

Referring to FIG. 7, a rear elevation view of a cannoli cream dispenser is illustrated according to the first embodiment of the present invention. Vents 178 are provided to enable air flow for cooling of the electrical and mechanical structures in the rear portion of the dispenser. The rear panel 176 is removable to enable servicing of the structures inside. A retractable power cord 179 is stored in the rear portion and projects out through the removable rear panel 176.

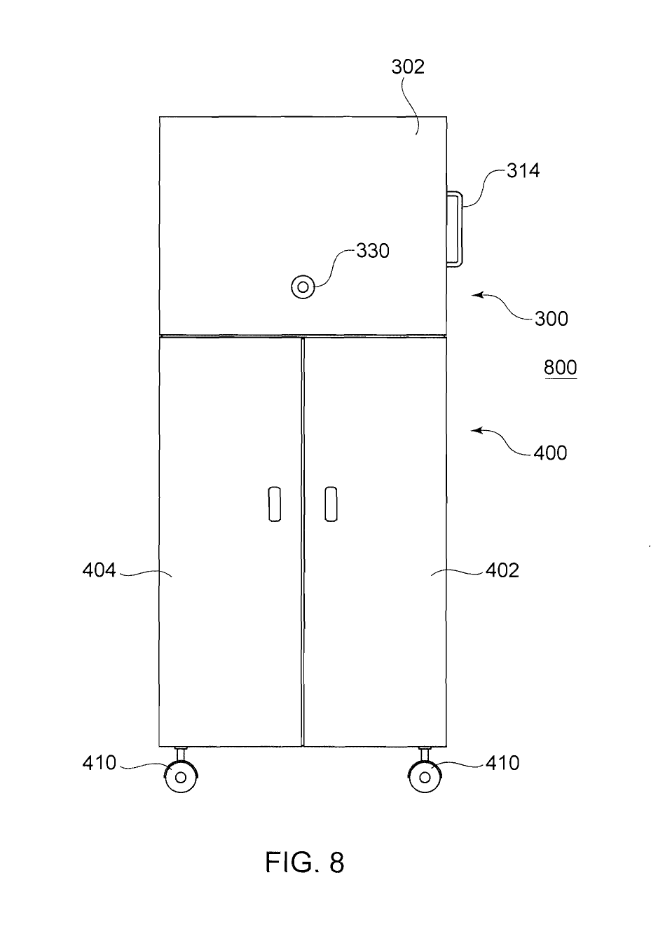

Referring to FIG. 8, an elevation view of a cannoli cream dispenser according to the first embodiment is illustrated in combination with an accessory cabinet. The combination 800 of the dispenser 300 atop the cabinet 400 is shown from the front. The dispenser has a nozzle 330 projecting from the front panel 302 and has a handle 314 for opening a side access door. The cabinet 400 is provided with wheels 410 to enable portability of the dispenser 300 while maintaining it at a serviceable operating height for use in a shop environment, such as a pastry kitchen or a delicatessen. Doors 402, 404 open to a shelved cabinet interior useful for storage.

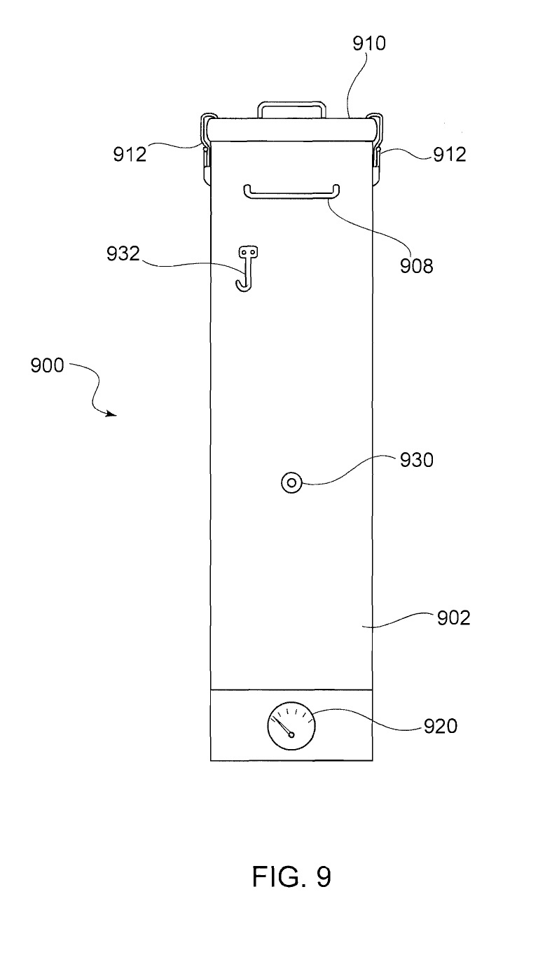

Referring to FIG. 9, a dispenser 900 for filling cannoli shells with cannoli filling is shown having a lid 910 at the top and a temperature gauge 920 to indicate the internal refrigeration temperature of the cannoli cream. Spring clips 912 are used to hold the lid 910 atop the dispenser. A transport handle 908 is useful to move dispenser around, either for placing it on a countertop or rolling it on removable wheels. An outlet coupling 930 projects from the front of the dispenser housing 902. A hose (not shown) couples in fluid communication with the outlet coupling 930 and directs flow of cannoli cream out through a nozzle. A swivel hook 932 supports the hose and nozzle for storage.

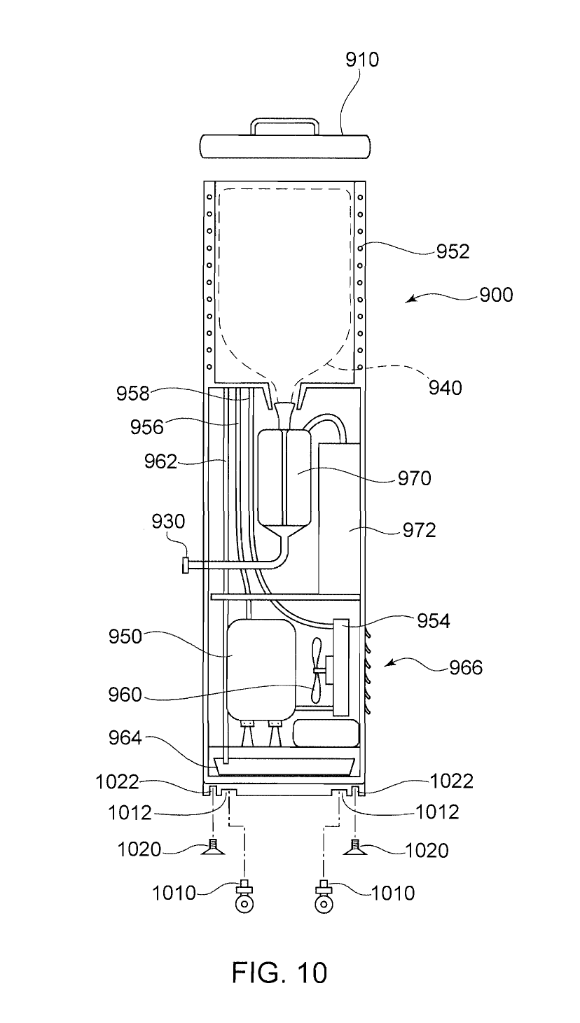

Referring to FIG. 10, the dispenser 900 is portable and contains a refrigeration unit to keep the cream filling chilled. The cannoli filling is held in a hopper 940 (shown in phantom) that is removably received in a top portion of the dispenser 900 that is sized to receivably house the hopper 940. Lid locks (refer to FIG. 9) are used to fasten the lid 910 down on the top of the dispenser. The top portion that receives the hopper 940 is lined with evaporator coils 952 from the refrigeration unit.

A piston driven mechanism 970 is housed in the center section of the dispenser. The piston drive 970 functions to pump cannoli filling from the hopper 940, out through the outlet 930, and through a flexible tube (not shown) to a dispenser nozzle. The center section also includes space to accommodate storage of the flexible tube and nozzle in a refrigerated condition. The piston drive 970 may be electric, pneumatic, hydraulic, or manually powered.

Other components of the refrigeration unit (condenser coils 954, compressor 950, expansion valve, etc.) are housed in a bottom portion of the portable dispenser. Cooling lines 956 and 958 provide for flow of working fluid between the evaporator 952 and the other refrigeration components. A fan 960 sends air through the condenser 954 and a ventilation louver 966 provides an exhaust path for heat laden air.

A pan 964 at the bottom of the dispenser structure catches any drainage. Drain line 962 provides a fluid path from condensate from the top of the dispenser to reach the pan 964. Electrical power to operate the refrigeration compressor 950 is provided via a retractable electrical cord disposed in the bottom portion. A power supply 972 provides power to operate the piston drive 970.

The underside of the dispenser has threaded bores 1022 for fixing of legs 1020 with suction cups to hold the dispenser in place on a counter top, and alternatively, receptacles 1012 for fixing wheels 1010 to roll the dispenser 900 around easily on the floor.

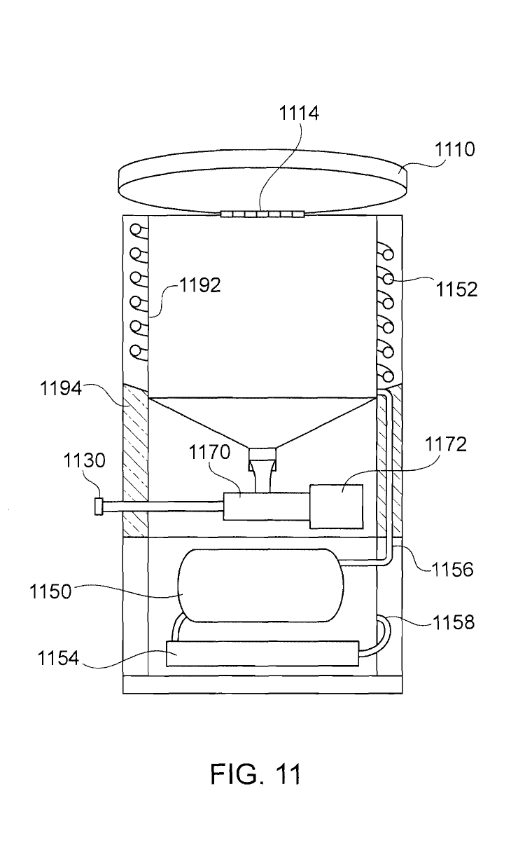

Referring to FIG. 11, the dispenser is a vertically elongated structure with a stainless steel outer surface to the housing. The housing has an inner jacket 1192 to allow condenser coil tubing 1152 to coil around the area that is to receive refrigeration and to provide a passage way for the ejection system 1170, 1172 wiring and for drainage of condensate. The top portion of the dispenser houses the cannoli cream while being refrigerated. This top portion is accessed via a lid 1110 on a hinge 1114 through which a hopper (refer to FIG. 10) is lowered. The middle portion has an insulation layer 1194 and contains a dispensing system with a piston drive 1170 and power supply 1172 that moves the cannoli cream in a controlled manner from the dispenser through outlet connector 1130 and into the cannoli shell by way of a flexible hose and nozzle (or tube). The bottom section houses the refrigeration unit (compressor 1150 and condenser 1154) that connects to the condenser coil 1152 via refrigeration lines 1156, 1158.

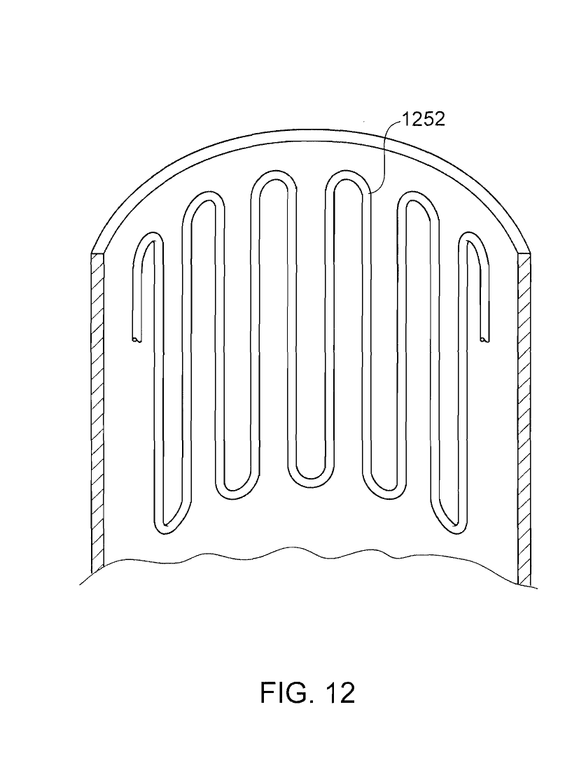

Referring to FIG. 12, a detail view shows how a refrigeration coil 1252 (i.e., evaporator coil) according to an exemplary embodiment surrounds the inner jacket in the refrigerated section. The vertical zig zag coil pattern 1252 provides for vertically even temperature distribution in the cooling chamber.

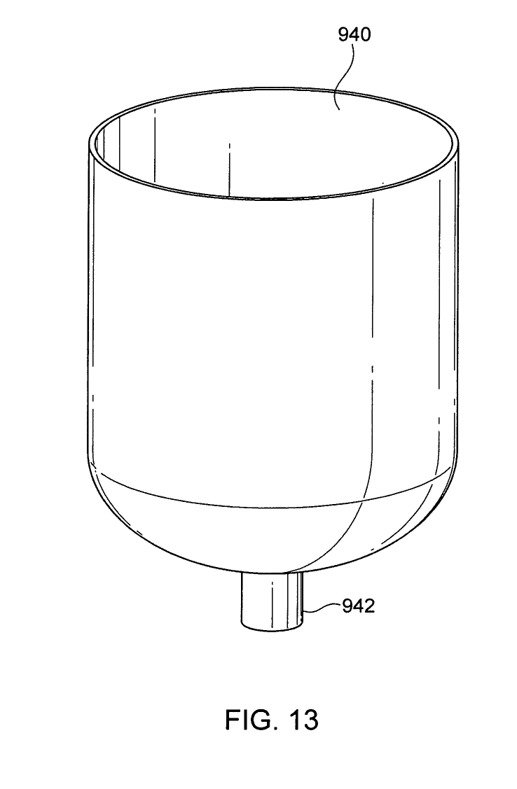

Referring to FIG. 13, a drop-in removable hopper 940 is shown for holding the canolli cream. The hopper 940 being removable provides convenience for cleaning and also permits the hopper to be removed from the dispenser and stored at night in a larger refrigerator so that the dispenser's refrigeration structure can be turned off to save energy. The narrow passage 942 at the bottom of the hopper 940 directs the contents of the hopper into the piston drive mechanism for dispensing.

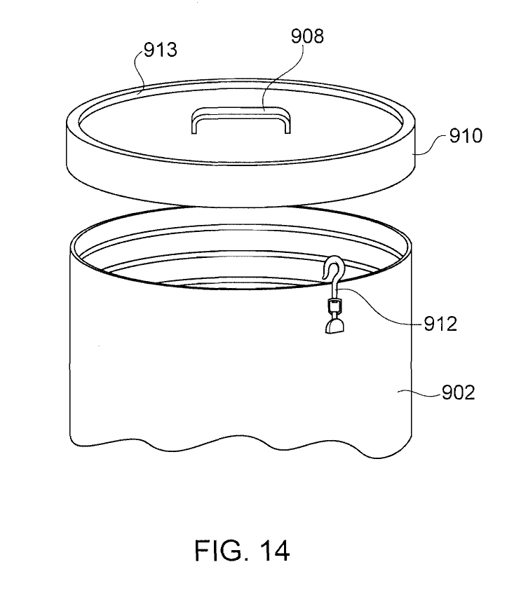

Referring to FIG. 14, the lid 910 is grasped via a handle 908 and is secured according to the second embodiment via a swivel hook 912 that engages a ledge 913 around the upper edge of the lid 910.

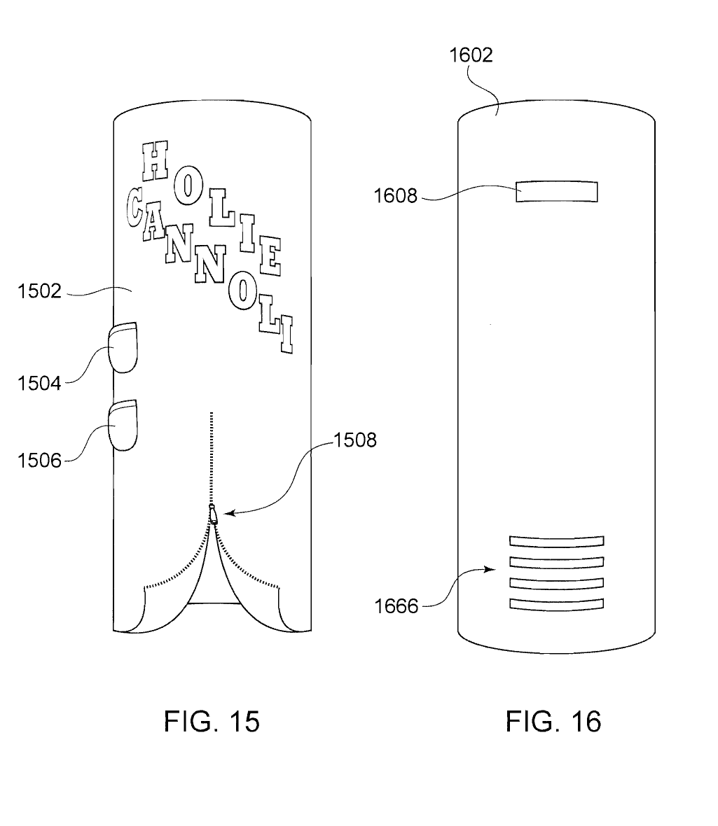

Referring to FIGS. 15 and 16, an outer blanket for the cannoli cream dispenser provides insulation and storage. For added insulation and for scratch protection, an outer blanket is optionally placed over the outside surface of the dispenser. A zipper 1508 partially opens the front side 1502 of the outer blanket for ease of installation and removal. Wheel pockets 1504, 1506 provide for ease of storage for the dispenser's wheels when in is being used on a countertop and portability is not needed. A handle on the back of the dispenser is accessible through a handle slot 1608 in the back side 1602 of the outer blanket. Ventilation for exhaust of heated air from the refrigeration unit is provided through slots 1666.

The wheels and the compact size of the dispenser give it the property of being readily portable. This is advantageous for maximizing useful space in a kitchen.

By having the lid in the top of the dispenser, rather than on the side, the refrigerated dispenser maximizes its energy efficiency. Heat energy is less likely to leak into the refrigerated compartment of the dispenser via seals around the top of the dispenser than via seals around a side-mounted door. The advantage of the side-mounted door of the first embodiment is ease of use.

The dispenser having a hose and nozzle for dispensing the cannoli cream is useful because it allows the user to hold the cannoli shell at any desired angle for filling (typically horizontally) rather than the undesirable vertical orientation that would be necessary with the fixed, vertically oriented dispenser apertures that have been used in the past.

According to one embodiment, the dispenser is about 36 inches tall with a diameter of about 8 to 10 inches. Each of the three sections of the dispenser are about 12 inches tall. The hopper is sized to hold about 15 pounds of cannoli cream, although this is not meant as a limitation. The nozzle is adapted to dispense portion controlled amounts of cannoli cream for each cannoli shell.

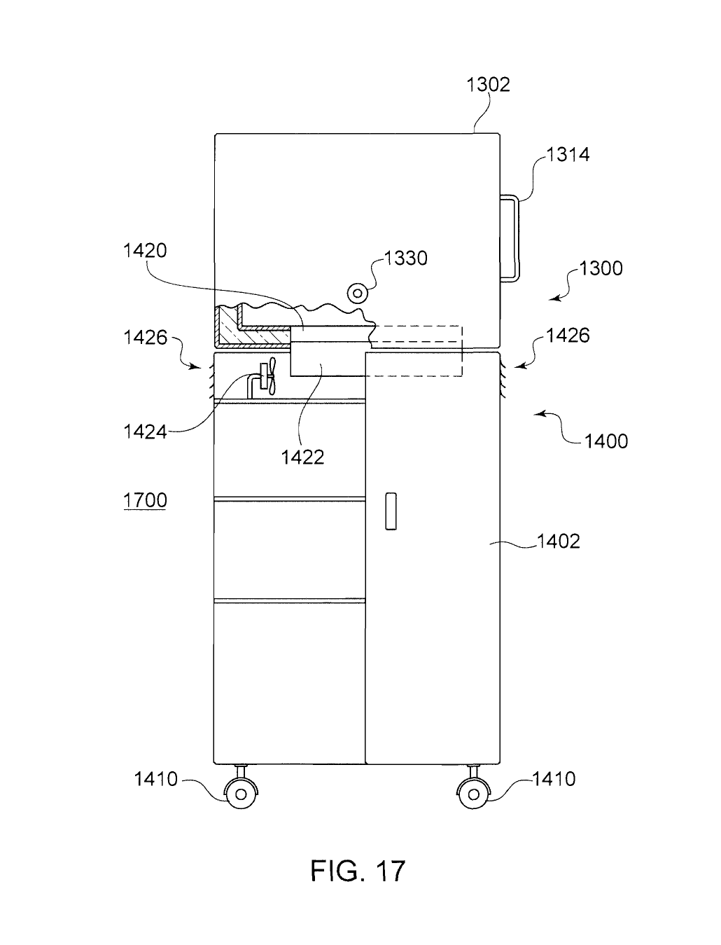

Referring to FIG. 17, an elevation view of a cannoli cream dispenser is illustrated according to a third embodiment. The dispenser 1700 according to the third embodiment combines a dispenser 1300 substantially like that of the first embodiment with a cabinet 1400. The dispenser has a nozzle 1330 projecting from the front panel 1302 and a door handle 1314 for a side access door. The cabinet 1400 has wheels 1410 and doors to enclose the front of the cabinet (the left door is omitted for ease of illustration, with only right side door 1402 shown).

The use of cold packs for cooling is supplemented by an auxiliary cooling system. A thermoelectric cooler 1420 employing Peltier cells is disposed in the bottom wall of the dispenser 1300 and has a heat sink 1422 extending out from the bottom of the dispenser into the top of the cabinet 1400. A fan 1424 moves air through the louvers 1426 and through the heat sink to exhaust heat energy from the cabinet. To provide for extended use time, the thermoelectric cooling structure 1420, 1422, 1424 waits in a standby mode until such time as the cold packs begin to lose the ability to maintain cool temperature in the cold chamber. At that time the thermoelectric system provides a supplemental cooling capacity. The thermoelectric system is utilized to provide a supplemental cooling function rather than primary cooling because it is less energy efficient than ice or other phase change cold pack devices.

Such a system can be useful in a restaurant setting. Further, since the unit is portable and easy to clean, it will find use for party rentals and private functions as a portable novelty dessert dispensing system.

A system and method for dispensing viscous food has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. An apparatus for storage and dispensing of viscous food material, the apparatus comprising:
a rigid housing;
a food material holder removably disposed in the housing;
a thermal storage material removably disposed in the housing adjacent the food material holder;
a piston driven food material transfer unit removable connected to the food material holder to move viscous food material from the food material holder out of the housing; and
a nozzle extending outside the housing and coupled to the food material transfer unit to direct movement of controlled portions of the viscous food material.

2. The apparatus of claim 1, further comprising plural wheels affixed at a bottom end of the housing.

3. The apparatus of claim 1, wherein the nozzle is adapted to dispense portion-controlled amounts of cannoli cream.

4. The apparatus of claim 1, further comprising plural spacers disposed on an inside wall of the rigid housing disposed to maintain an air space between the thermal storage material and the inside wall.

5. The apparatus of claim 4, further comprising a fan inside rigid housing to move air around the holder and the members of thermal storage material.

6. The apparatus of claim 1, further comprising a fan inside rigid housing to move air around the holder and the members of thermal storage material.

7. A method for storing and dispensing of chilled viscous food material, the method comprising:
holding the viscous food material inside a portable housing;
maintaining the temperature of the chilled viscous food material inside the housing a thermal storage material disposed inside the housing adjacent the food material; and
dispensing outside of the housing a portion controlled amount of the viscous food material.

8. An apparatus for storage and dispensing of viscous food material, the apparatus comprising:
a rigid housing;
a food material holder removably disposed in an upper portion of the housing;
a refrigerator comprising a compressor, an evaporator, and a condenser, the compressor and condenser being disposed in a lower portion of the housing and the evaporator being disposed in the upper portion of the housing adjacent the food material holder;
a piston driven chamber removable connected to the food material holder to move viscous food material from the food material holder out of the housing; and
a movable nozzle disposed outside the housing and coupled to the piston drive chamber to direct movement of controlled portions of the viscous food material.

9. The apparatus of claim 8, further comprising plural wheels affixed at a bottom end of the housing.

10. The apparatus of claim 8, wherein the nozzle is adapted to dispense portion controlled amounts of cannoli cream.

11. An apparatus for storage and dispensing of viscous food material, the apparatus comprising:
a rigid housing;
a food material holder removably disposed in the housing;
one or more members of thermal storage material removably disposed in the housing adjacent the food material holder;
a thermoelectric cooler disposed in a bottom wall of the rigid housing adjacent the food material holder;
a piston driven chamber removable connected to the food material holder to move viscous food material from the food material holder out of the housing; and
a movable nozzle disposed outside the housing and coupled to the piston drive chamber to direct movement of controlled portions of the viscous food material.

12. The apparatus of claim 11, further comprising plural wheels affixed at a bottom end of the housing.

13. The apparatus of claim 11, wherein the nozzle is adapted to dispense portion controlled amounts of cannoli cream.

14. The apparatus of claim 11, wherein the thermoelectric cooler further comprises a heat sink extending through the bottom wall of the housing.

15. The apparatus of claim 14, further comprising a cabinet supporting the rigid housing, the heat sink extending into a top portion of the cabinet.

16. The apparatus of claim 15, further comprising a fan disposed inside the cabinet at a location to direct air to flow across the heat sink.

17. The apparatus of claim 11, further comprising plural spacers disposed on an inside wall of the rigid housing disposed to maintain an air space between the members of thermal storage material and the inside wall.

18. A method for storing and dispensing of viscous food material, the method comprising:
holding the viscous food material inside a portable housing;
chilling the viscous food material inside the housing a thermal storage material disposed inside the housing adjacent the food material;
chilling the viscous food material inside the housing a thermoelectric cooler disposed in a wall of the housing; and
dispensing outside of the housing a controlled portion amount of the viscous food material.
